(19) United States
(12) Patent Application Publication
(10) Pub. No.: US 2016/0132314 A1
(43) Pub. Date: May 12, 2016

(54) REMOTE CONFIGURATION MANAGEMENT OF APPLICATIONS

(71) Applicant: Amazon Technologies, Inc., Seattle, WA (US)

(72) Inventors: Marc Solsona-Palomar, Bellevue, WA (US); Luis Arnoldo Romero, Bellevue, WA (US); Paul David Truax, Seattle, WA (US); Joanne Jeannette Marie Polsky, Seattle, WA (US); Aaron Scott Willeke, Seattle, WA (US); Benjamin Christian Blount, Seattle, WA (US); Greg William Tan, Seattle, WA (US); Pinku Prakash Karthikeyan, Chennai (IN)

(21) Appl. No.: 14/537,882

(22) Filed: Nov. 10, 2014

(51) Int. Cl. G06F 9/445

(52) U.S. Cl. CPC G06F 8/65; G06F 9/44505

(57) ABSTRACT

Disclosed are systems, methods, and computer-readable media for remotely updating deployed applications by changing the values of modifiable variables incorporated in the applications. Developers can define segments with attributes and deliver customized configurations for those segments. Also disclosed is a method for resolving conflicts, based on prioritization, if an application instance matches more than one segment.

### BACKGROUND

Consumers and business entities are increasingly using computing devices, including mobile devices, to perform various personal, work and business-related tasks. Computing devices allow consumers and business entities to perform many functions, such as accessing and displaying websites, sending and receiving electronic mail, capturing and displaying images, creating a document, playing videos, playing music and other forms of audio, engaging in social networking, etc. These functions are performed by software applications that typically run on top of the operating systems of the computing devices.

There is a growing demand for applications to use on computing devices. Application stores help users find and download applications for, among other things, their mobile devices. Such application stores are often accessed from a device that is connected to a network (such as, for example, the Internet) through which the stores present a user with applications available for purchase or download. Many developers distribute their applications through the stores which serve as a marketplace for applications.

To update the behavior or functionality of a previously-released application, a developer must create, test and publish new versions of the application for each computing platform that the application supports. Computing platforms vary based on, among other things, operating systems, service carriers (for mobile devices), available hardware resources, and available software resources. After new versions of the application are created and published through an application store, it can take time before a significant number of customers have installed the updated application. To reduce delays in updating their applications, some developers have created their own application management systems as an alternative way to distribute updates to applications they have developed. However building, scaling and maintaining a developer-run application management system can be difficult, expensive, and distracting from the developer's main business of developing applications.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the invention.

FIG. 1 is a network diagram schematically illustrating an example of an environment for remotely managing the configuration of applications installed on user devices;

FIG. 2 is a simplified block diagram illustrating the data structure of an embodiment of the disclosed systems, methods and computer-readable media for remote configuration management of applications;

FIG. 3 is a flow diagram for one embodiment of a process for resolving conflicts between multiple segments for remote configuration management of applications; and

FIG. 4 is a functional block diagram of an example general purpose computer system suitable for use in executing the functions of the disclosed remote configuration management system and services.

### DETAILED DESCRIPTION

The present disclosure relates to systems, methods, and computer-readable media to remotely manage configurations of applications. More specifically, aspects of the present disclosure relate to facilitating the management of targeted features and behaviors of installed applications. Illustratively, the disclosed system can modify applications, such as, for example, a level of game difficulty or an ad network provider, by transmitting updates to modifiable variables incorporated into the application.

In some embodiments, the system allows for segmentation of the installed base. The system can define segments according to attributes reflective of, among other things, the user and the user's platform, such as, for example, device type, user's age, or geographical region. Membership in a segment is determined by comparing attributes to a rule, where the rule has one or more conditions.

Also disclosed herein are systems, methods and computer-readable media for defining which parts of an application are controlled by modifiable variables. A developer incorporates a client-side software development kit (SDK) into the application. The SDK includes libraries and code to enable the applications to interact, as a client, with the remote configuration management system and services disclosed herein. A set of modifiable variables are incorporated into the application. A configuration control program is also incorporated into the application to control and schedule interactions with the disclosed remote configuration management system and services and configuration updates.

Testing and publishing tools are provided to help ensure a reliable and error-free deployment when new configurations are staged for release. In an embodiment, the system can export a configuration and include it in an application build for testing. In a manner similar to that described above, illustratively the SDK includes libraries and code to enable the applications to interact, as a client, with the remote configuration management system and services to manage the distribution/deployment of the new configurations.

In an embodiment an analytics service can be integrated into the application. The analytics service enables automated evaluation of the use and impact of configuration updates once the updates are distributed to the installed base.

In an embodiment, the remote configuration management system can include a group service, or access control service, that executes access control by providing temporary, limited privilege credentials to access the remote configuration management system resources. In an embodiment the identity broker service supports both authenticated users and unauthenticated guests, so application users do not have to be logged in with credentials in order for an application to receive configuration information updates.

Various aspects of the disclosure will now be described with regard to certain examples and embodiments, which are intended to illustrate, but not to limit the disclosure. Nothing in this disclosure is intended to imply that any particular feature or characteristic of the disclosed embodiments is essential. The scope of protection is defined by the claims.

### I. Remote Configuration Management System Overview

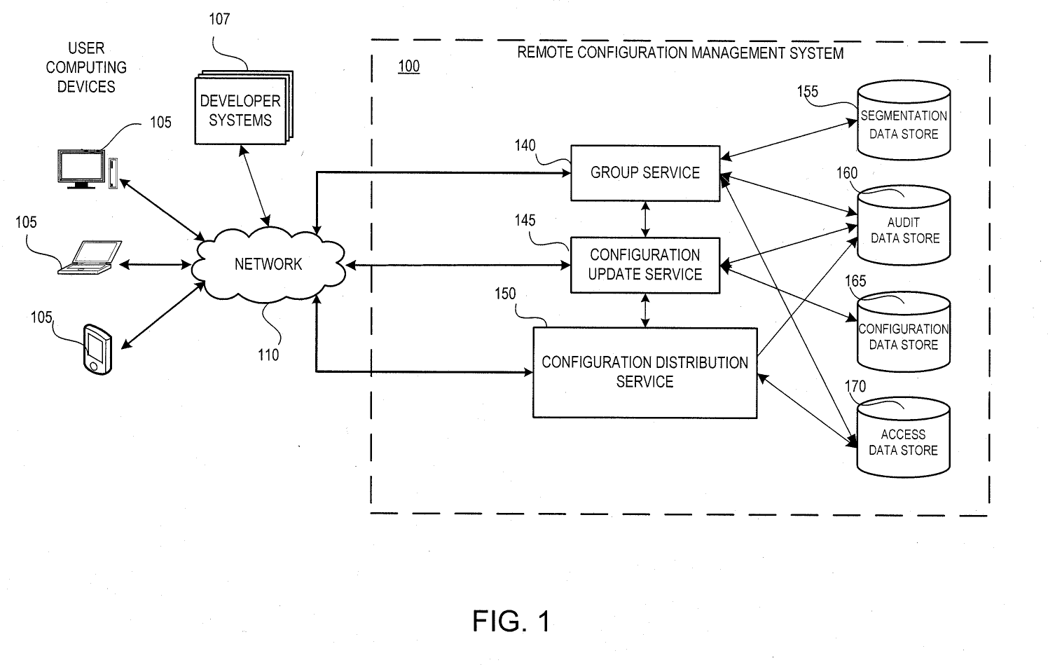

FIG. 1 is a network diagram schematically illustrating an example of an environment for remotely managing the configuration of applications installed on user devices 105 (which many be referred to in the singular as “a user device,” or in the plural as “user devices”). In the context of the present disclosure a user device 105 may also be referred to as a client that accesses services made available by one or more servers. A remote configuration management system 100 can communicate with user devices 105 and with developer systems 107 using a network 110. The remote configuration management system 100 can receive requests to update the configuration of an application installed on that user device 105. For example, the remote configuration management system 100 can obtain requests from the developer systems 107 to update a configuration. In response to the request, the remote configuration management system 100 can provide, directly or indirectly, an updated configuration to the user device 105. The remote configuration management system 100 updates a deployed application by providing an updated configuration, having updated values for one or more modifiable variables. Modifiable variables make it possible for an application to process different sets of data at different times. Rather than entering data directly into an application, a developer can use one or more modifiable variables to represent the data. A modifiable variable has a name and a data type associated with it. The data type indicates what sort of value the variable represents, such as, for example, an integer, a character, or a string. When the application is executed, the modifiable variables are replaced with data corresponding to the current value defined for each modifiable variable. Thus modifiable variables can be updated with name-value pairs that identify the variable to be updated (by its name) and the data to be replaced during execution (with its value). By incorporating modifiable variables into the application, the application can be modified without having to develop, test and deploy a new version of the application. In this manner modifiable variables enable developers to write flexible applications. In the present disclosure, modifiable variables are referred to hereinafter as configuration items. Configuration items make up a configuration.

The user device 105 may be any type of computing device, such as wireless mobile devices (such as smart phones, PDAs, tablets, e-book readers or the like), desktops, laptops, video game platforms, television set-top boxes, televisions (e.g., internet TVs), and computerized appliances, and the like. Further, it is possible for the user devices 105 to be different types of devices, to include different applications, or to be otherwise configured differently. In addition, the user devices 105 can include any type of operating system (“OS”). For example, the user devices 105 can implement an Android™ OS, a Windows® OS, a Mac® OS, an iPhone or iPad OS (iOS), a Linux or Unix-based OS, or the like.

In an embodiment, the remote configuration management system 100 enables definition of segments. A segment is a group of application instances that match a rule. Membership in a segment is determined by comparing attributes to a rule, where the rule has one or more conditions. The rule is evaluated by performing a logical conjunction operation (i.e., “ANDing”) on the conditions specified in the rule. Membership of an application instance in a segment occurs when all conditions of the rule are met. Members of segments receive customized updates to the applications, tailored for those segments. Illustratively, such segments can be based on, for example, the user's age, the type of user device 105, the mobile service carrier, the user's selected language, or the geographical region in which the user device 105 is located. The remote configuration management system 100 enables creation of customized configurations that can be tailored for the members of segments.

In some embodiments, the contents of the updated configuration delivered to a particular user device 105 can depend on user-specific information or device-specific information. In some embodiments the contents of the updated configuration delivered to a particular user device 105 can depend on user-specific and device-specific information, or other information, such as, for example, time of year.

The remote configuration management system 100 can include any computer-based system capable of receiving the configuration information from developers and providing the updated configuration to application users. The configuration updates can be made available via download, streaming, application virtualization, or the like.

The remote configuration management system 100 can include one or more servers for receiving and responding to network requests from, or otherwise communicating with, the user devices 105 or the developer systems 107. In particular the remote configuration management system 100 can also include a group service 140, a configuration update service 145, and a configuration distribution service 150. The group service 140, configuration update service 145 and configuration distribution service 150 may be implemented by execution of code modules on one or more servers, or on separate servers or on other computing devices. In an embodiment the group service 140, configuration update service 145, and configuration distribution service 150 may also be implemented on the developer systems 107. The remote configuration management system 100 can also include a configuration application data store 160 for storing application-related configurations, and an auditing data store 170 for retaining historical records of configuration updates, and a segmentation data store 180 for storing rules and conditions that define membership in segments of the application's installed base. The remote configuration management system can also include a software development kit (not shown) that can be incorporated into the application to support client-side engagement with the configuration distribution service 150 on the server-side. Other services may also be provided by the remote configuration management system 100.

Communication between user devices 105 and the remote configuration management system 100 is via the configuration distribution service 150. The configuration distribution service 150 authenticates requests for configuration information submitted to the remote configuration management system 100 from user devices 105. In an embodiment, the configuration distribution service 150 uses an access control protocol that includes an access key ID and a secret access key. The configuration distribution service 150 enables developers to create unique identifiers for end users. The unique identifiers are kept consistent across devices and platforms. The configuration distribution service 150 also delivers temporary, limited-privilege credentials to the application to access the resources of the remote configuration management system 100. In an embodiment the configuration distribution service 150 permits access to the remote configuration management system 100 by unauthenticated guest users, and by users authenticated through a public identity provider.

In an embodiment, unauthenticated identities are associated with a device. The configuration distribution service 150 will keep the unique identifier that has been generated for an end user consistent when that user accesses the service from the same device. Authenticated users have a unique identifier that follows them across devices, even if they use different operating systems. In an embodiment, an application operating on the user device 105 is in communication with the configuration distribution service 150 in order to provide the application with access to configuration updates. In an embodiment, integration with a user identity and data synchronization service is not required. Using an integrated identity broker can simplify the process of retrieving access keys for many developers. Using an integrated identity and data synchronization service allows the remote configuration management system 100 to support authenticated and anonymous user login scenarios, while enabling the configuration distribution service 150 to validate what application is making configuration requests. The configuration distribution service 150 may be accessed by an interface such as a network application interface (e.g., a web server), an Application Programming Interface (API), or other type of interface. In an embodiment the developer can create custom interfaces to the remote configuration management system 100 by calling server-side APIs directly.

The configuration update service 145 includes services for modifying the configuration of an application. It is the service to which developers gain access to update configurations for their applications, among other things. In some embodiments the configuration update service 145 uses a baseline configuration to update all instances of a deployed application. Accordingly, updates to the baseline configuration will be distributed in response to update requests from the entire installed base of the application.

The group service 140 includes services for managing the segmentation of the the installed base. In some embodiments, the group service 140 delivers provides facilities for the developer to define one or more custom configurations that may be targeted at one or more segments of the installed base. Rules are used to define which updated configuration a given device 105 will receive, based on attributes collected from the user device 105. An attribute is string (or other data type) that describes a property about the client application instance. In an embodiment, attributes are predefined such as, for example, a user device model or the selected language. In an embodiment, attributes include pre-defined attributes discoverable from the user device 105, such as, for example, the brand, make, model number, operating system and operating system version of the user device 105, and the language and country from preferences set by the user of the user device 105, and so on. In some embodiments the attributes include custom attributes, incorporated into the application during the development process, to provide segmentation granularity as desired by the developer. Illustratively, examples of custom attributes may include the last completed level of a game, or the date on which the application was last opened. In an embodiment, the group service 140 establishes priorities of segments to resolve conflicts when a user fits into more than one segment.

In an embodiment an analytics service can be integrated into applications. The analytics service delivers metrics relating to application usage by members of the installed base. Access to the analytics service and be provided by an analytics service console. In an embodiment an analytics service can be used to track configurations used by each user. In an embodiment the analytics service permits the writing of custom queries to assess engagement impact for each configuration used. In an embodiment the analytics service provides custom funnel charts to the console providing engagement charts by specific configuration. In an embodiment engagement metrics are provided in the context of their associated configuration deployment rules so that configurations can be evaluated and tailored for different segments such as, for example, big spending customers or high usage customers. In an embodiment metrics for configuration changes received by the application can be collected and evaluated. For example, the analytics service can track monthly requests across a line of applications. For each application, daily, weekly, and monthly requests are shown as well as the number of unique applications for the baseline or for any given segment. In some embodiments, the remote configuration management service provides the capability to conduct market research.

The configuration distribution service 150 receives application-generated update requests, and delivers updated configurations to user devices 105 in response. The configuration distribution service 150 performs a load operation which downloads the most recent configuration based on the latest attribute values from the user device 105. In an embodiment, the load operation is performed by the configuration distribution service 150 directly. In an embodiment the load operation is performed by calling an API of the configuration distribution service 150. In an embodiment the configuration updates are stored in the configuration data store 165 and archived in the auditing data store 160170. In an embodiment the client-side SDK, incorporated into the application, stores a local copy of the configuration to be accessible when the user device is off-line. The client-side SDK also provides tools to export a configuration into the application, in case the application is started for the first time without network connectivity. Developers can publish new configurations through the remote configuration management system 100 or by accessing a configuration update interface such as a network application interface (e.g., a web server), an Application Programming Interface (API), or other type of interface. In an embodiment the last successful load operation can be persisted on the user device 105. The client-side SDK includes an API to retrieve the time when the last successful configuration load was completed, so the application can retry if necessary.

With continued reference to FIG. 1, the remote configuration management system 100 can be associated with a number of data store to facilitate the functionality associated with the above-illustrated services. For example, the remote configuration management system 100 can include a segmentation data store 155 for maintaining segmentation information associated with functionality implemented by the group service 140. The remote configuration management system 100 can also include an audit data store 160 for maintaining audit information utilized by the group service 140, the configuration update service 145 and configuration distribution service 150. The remote configuration management system 100 can further include a configuration data store 165 for maintaining the configuration information utilized by the configuration update service 145. Still further, the remote configuration management system 100 can also include an access data store 170 utilized by group service 140 and configuration distribution service 150. Although the data stores illustrated in FIG. 1 are illustrated as single data stores, one skilled in the art will appreciate that the data stores may be implemented as multiple data stores, redundant data stores or distributed stores. Accordingly, the data stores identified in FIG. 1 are illustrative in nature.

### II. Data and Control Structures

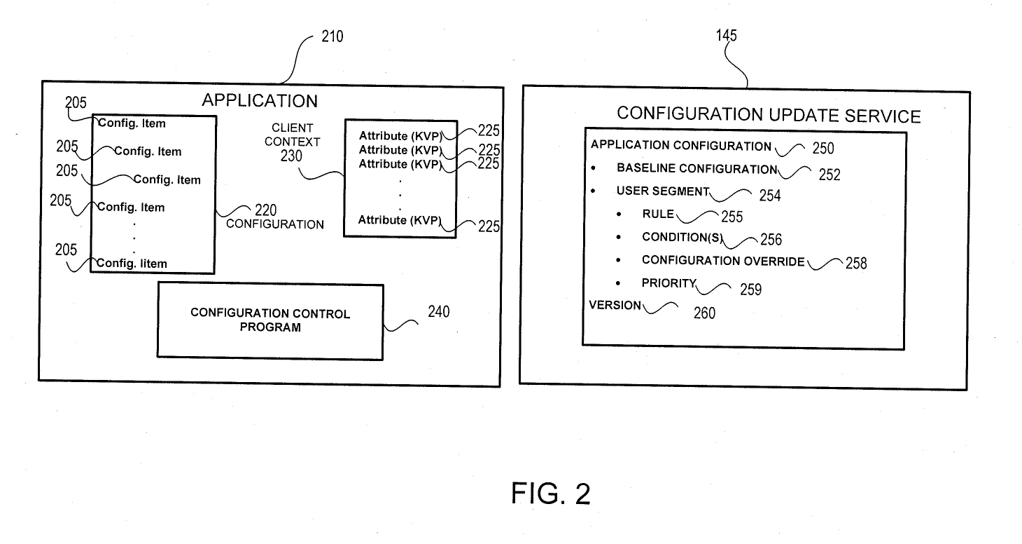

FIG. 2 is a simplified block diagram illustrating data and control structures of an embodiment of the disclosed systems, methods and computer-readable media for remote configuration management of applications. An application 210 has been developed and installed on a user device 105 (not shown). Among other things, the application 210 has incorporated into it a set of configuration items 205. A configuration item 205 comprises a key-value pair (KVP) which is a data representation model that supports an open-ended data structure. The KVP data representation model enables modification to the application 210 without the need to revise existing code or data structures. A KVP is expressed as a tuple, having a name and a value, and may also be referred to as a name-value pair, a field-value pair, or an attribute-value pair. One skilled in the art will readily appreciate that other data representation models can be used for configuration items without departing from the scope of the present disclosure.

As part of the application 210 development efforts, the developer incorporates configuration items 205 into the application 210 corresponding to portions, aspects, or features of the application 210 that the developer anticipates may be modified in the future. Illustratively, a configuration item 205 can control, for example, a background color of an application. In an embodiment the configuration items 205 include numbers, strings, number set, and string set data types. One skilled in the art will readily appreciate that configuration items 205 can include a wide variety of data types. In an embodiment configuration items 205 include large binary data types. In an embodiment a configuration item 205 delivers a uniform resource locater (URL) that points to a large binary object. The application can access the large binary data object independent of the remote configuration management process.

A configuration 220 is the set of configuration items 205 that are incorporated into the application 210. As illustrated in FIG. 2, configuration items 205 can be organized in a nested structure which enables grouping, subgrouping, sub-subgrouping, etc., of related configuration items. In an embodiment the configuration items 205 can be organized into a configuration 220 in a nested document, such as, for example, in a Java Script Object Notation (JSON) document format. In an embodiment a configuration 220 is defined in a JSON document, in which configuration items 205 can be grouped, and objects can be organized in a nested structure. One skilled in the art will readily appreciate that many other data formats and organizational structures can be used without departing from the scope of the present disclosure.

In an embodiment the developer can create specific configurations 220 and segments 254 for each application that the developer develops and distributes. In an embodiment the developer can create one master configuration 220 for all applications and take advantage of segmentation capabilities, with targeted overriding, for different applications.

Also incorporated into the application 210 is a set of attributes 225. An attribute 225 is a string (or other data type) that describes a property about a particular user application 210 instance, such as, for example, the name of the operating system running on the user device 105. Each request for a configuration update includes a list of attributes 225 in a client context 230. In an embodiment, attributes are represented as key-value pairs. The SDK includes a number of built-in attributes, and the developer can define additional, custom attributes to better fit particular use cases. Developers can target a specific segment 254 by specifying a single value or a range of values for these attributes. In an embodiment, the SDK includes the following built-in attributes: brand, the consumer-visible brand with which the user device 105 will be associated; manufacturer, the manufacturer of the user device 105; model, the end-user-visible name for the user device 105; OS name, the name of the operating system running on the user device 105; OS version, the version of the operating system running on the user device 105; language, the language from the locale preference set on the user device 105; country, the country from the locale preference set on the user device 105; screen height, the absolute height of the display (in pixels) of the user device 105; screen width, the absolute width of the display (in pixels) of the user device 105; screen scale, the scaling factor between the user device's 105 density-independent coordinates and physical coordinates; screen density, the screen density (expressed in dots-per-inch) of the user device 105; application identifier, the identifier for the application 210 installed on the user device 105; application version, the version of the application 210 installed on the user device 105; and device ID, the identification code that uniquely identifies the user device 105. One skilled in the art will appreciate that there are many other elements of descriptive information that can define a property of the user application instance that may be included as attributes.

In an embodiment the remote configuration management system 100 enables including attributes from external sources, such as, for example, a user identity generated by a third party service, such as a data synchronization service. Using the data from such services will give the developer more flexibility to refine in which segment the user belongs. For example, if the developer stores segmentation data in a user identity and data synchronization service, that information could be used to segment users in the remote configuration management system 100.

In an embodiment the developer defines custom attributes 225 that are specific to the application 210 under development. Custom attributes 225 can also be specific to the business objectives pursued by that application 210. In an embodiment the application 210 includes both built-in and custom attributes 225. A client context 230 is a set of client attributes with values that describe a specific user application 210 instance. In an embodiment the client context 230 is transmitted to the remote configuration management system 100 along with a request to receive an updated configuration 220. In an embodiment, custom attributes are persisted on a user device 105. They can be used for any future configuration requests to the remote configuration management system 100, including across application restarts.

In an embodiment a configuration control program 240 is incorporated into the application 210 as part of the client-side SDK. The configuration control program 240 provides services including requesting a configuration update, transmitting a client context 230, receiving an updated configuration 220, and replacing the previous configuration 220 with the updated configuration 220. The configuration control program 240 controls scheduling of update requests transmitted from the application 210 to the remote configuration management system 100, such as, for example, upon application launch. The configuration control program 240 also controls scheduling of updates to the configuration. For example, an update to the configuration 220 that changes the application's 210 background color from green to red can be scheduled to occur at a specific date and time, specified by the developer. The configuration control program 240 will make the update at the designated date and time. In an embodiment the application 210 sends a request for configuration update at application startup. In an embodiment the application 210 sends a request for configuration update in response to a push notification. In an embodiment the remote configuration management system 100 provides data to the application indicating when the configuration 220 was last updated in response to a request for update.

The configuration update service 145 enables the developer to modify the application 210 once it has been deployed to an installed base. An application configuration 250 is a set of all the information needed to update an application 210 including a baseline configuration 252. The baseline configuration 252 is the configuration that user devices 105 receive by default, i.e., if the user device 105 does fit into a segment 254 that qualifies for a custom configuration. The application configuration 250 can also include one or more segments 254. Each segment 254 includes a rule 255, made up of one or more conditions 256, all of which must be met for a user device 105 to be included in the segment 254.

A configuration override 258 is a set of instructions that modify one or more values of configuration items in the baseline configuration. The configuration override 258 serves to define the customized configuration 220 for the segment 254 to which it is associated. For the purpose of illustration, let us assume, for example, the baseline configuration 252 sets a configuration item 205 that controls the application's 210 background color to green, and the developer wants to set the background color to red for users in France who have version 3 of the application. The developer defines a segment 254 by a rule 255 that determines membership in the segment 254. The rule has two conditions 256. The first condition 256 is that the country locale is set to France, and the second condition is that the instance application version is version 3. Accordingly, user devices 105 that meet these two conditions 256 will be members of the segment 254. When a user device 105 that is a member of the segment 254 receives a configuration update, the configuration update will be based on the configuration override 258 associated with the segment 254, which in this illustrative example, would set the background color to red. In an embodiment, the configuration 220 is updated by updating the baseline configuration 252, and then by modifying the baseline configuration 252 with the values for the configuration items 205 specified in the configuration override 258. In an embodiment, the configuration 220 is updated by substituting the configuration override 258 for the baseline configuration 252. In an embodiment the configuration update service 145 includes a configuration revision service that enables developers to specify data retention requirements for configurations of a particular application.

A version 260 is an editable snapshot of the application configuration 250. A version 260 can be edited, tested, published and cloned. In an embodiment only one version 260 of an application configuration 250 can be active at any time. In an embodiment, a new version 260 is created by cloning an existing version 260.

In an embodiment, the remote configuration management system 100 provides an environment, facilities and services to test an application configuration 250 before activating and publishing it. In an embodiment, a version can be tested by developers using diagnostic tools that can be accessed, for example, via a management console. The diagnostic tools enable a developer to modify the data elements of an application configuration 250 and then observe the results, without the need to deploy the application configuration 250 that is being modified in the operational environment. In an embodiment, the management console (which can be accessed from a developer system 107) can simulate the behavior of a run-time client, i.e., user device 105. A developer can input test values for attributes 255 and then submit a request for update to the experimental application configuration 250, all within a test environment. In an embodiment, a test version 260 of an application configuration 250 can be tested by external users. The external users can use a special link to start the application 210 and gain access to a test environment. For example, designated test users can access a test site, using, for example, a quick response (QR) code. Once in the test environment, the application 210 can be updated with the test version 260 of the application configuration 250, and the behavior of the test user's device 105 can be evaluated. The test user's device 105 can be reset to the current deployed version 260 of the application configuration 250 upon completion of the test.

### III. Conflict Resolution

A client can potentially match multiple segments 254. This allows developers to define segments 254 for orthogonal concerns, a useful capability for various business analytics and optimization strategies, among other things. As the number of orthogonal segments 254 increases, the number of possible combinations that a user device 105 could match increases factorially. In the absence of an alternative segment 254 conflict resolution approach, the developer would be required to specify custom configurations 220 for all possible combinations, which could become burdensome. In an embodiment, the developer specifies a priority 259 ranking for each defined segment 254. To resolve such conflicts in an efficient manner, the configuration update service 145 evaluates all segments 254 and applies each applicable configuration override 258, sequentially, in an order from lowest priority 259 to highest priority 259. In this manner, the developer is only required to specify a baseline configuration 252 and a single configuration override 258 for each defined segment 254.

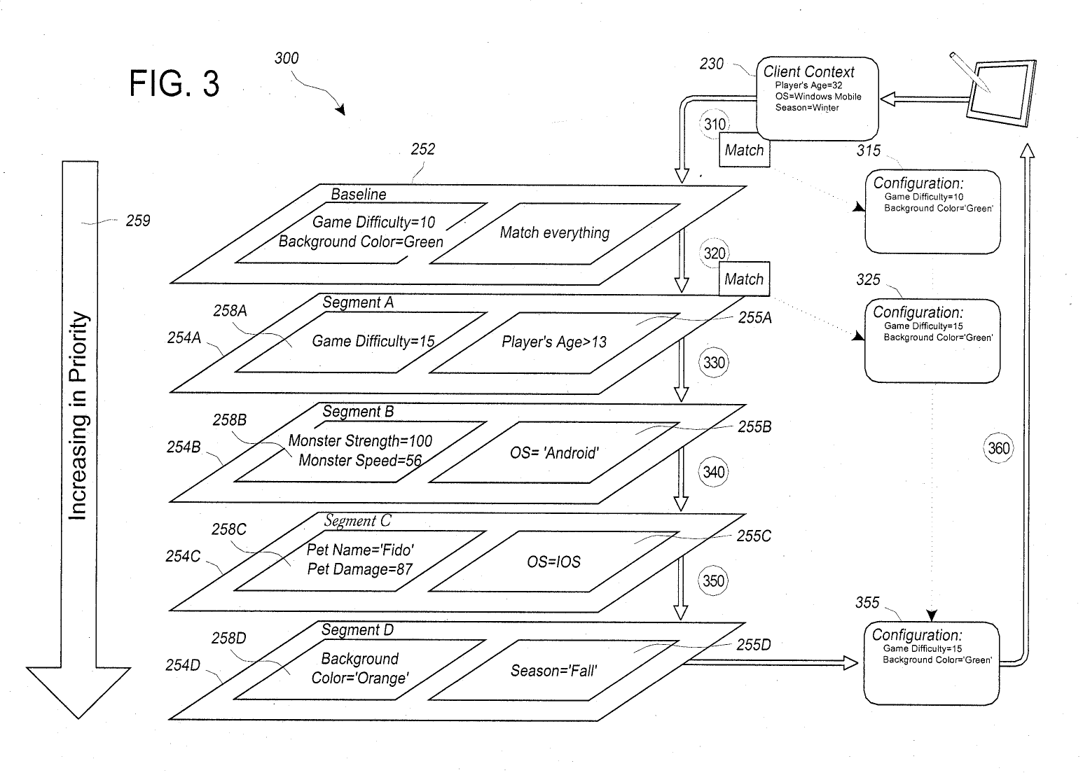

FIG. 3 illustrates a flow diagram for one embodiment of a process 300 for resolving conflicts between multiple segments 245. The process 300 begins at block 310 where a client context 230, transmitted from a specific user device 105, along with a configuration update request, is received by the remote configuration management system 100. In this illustrative example, the client context 230 identifies the player's age as 32, the operating system as Windows mobile, and the season as winter.

At block 315, the configuration update service 145 applies the updates specified in the baseline configuration 252, namely, game difficulty set to 10, and background color set to green, because the baseline configuration 252, as the default configuration, matches all client contexts. In an embodiment, as reflected in the example of FIG. 3, only changes to a baseline configuration 252 are applied to a user device 105 configuration update.

At block 320 the configuration update service 145 compares the client context 230 with the rule 225A for segment A and determines that they match. Rule 255A requires that a player's age be greater than 13, and the player's age, as reflected in the client context 230, is 32.

At block 325 the configuration update service 145 applies the updates specified in the configuration override 258A of segment A 254A, namely, game difficulty set to 15. The background color remains set to green, as previously set by the baseline configuration 252, because the configuration override 258A does not define a change to that configuration item 205.

At block 330 the configuration update service 145 determines that the client context 230 does not match the rule 255B for segment B 254B because the operating system of the client context 230 is different than the operating system specified by the rule 255B. Since no match is determined, no override is made to the user device 105 configuration.

At block 340 the configuration update service 145 determines that the client context 230 does not match the rule 255C for segment C 254C because the operating system of the client context 230 is different than the operating system specified by the rule 255C. Since no match is determined, no override is made to the user device 105 configuration.

At block 350 the configuration update service 145 determines that the client context 230 does not match the rule 255D for segment D 254D because the season of the client context 230 is different than the season specified by the rule 255D. Since no match was determined, no override is made to the user device 105 configuration.

At block 355, the configuration update service 145 completes evaluation of whether the client context 230 matches rules of each segment 254, and defines the final configuration update for the user device 105. The sequence of determination is made in the order of increasing priority 259 to ensure that the final configuration that is transmitted to update the user device 105 reflects the highest priority configuration override(s) 258, in the event that the client context 230 matches rules 255 for more than one segment 254.

At block 360, the configuration distribution service 150 transmits a final, updated configuration (reflected in block 355) to the user device 105, at which time the process 300 terminates.

In an embodiment the remote configuration management system 100 uses a large, distributed system of servers deployed in multiple data centers across the Internet, typically in multiple geographical regions. Such a distributed network for distributing configuration information can utilize additional technologies, such as caching, server-load balancing, request routing, and content services, among others. Additionally, the distributed network maintains the functionality associated with the configuration distribution service 150, such segmentation.

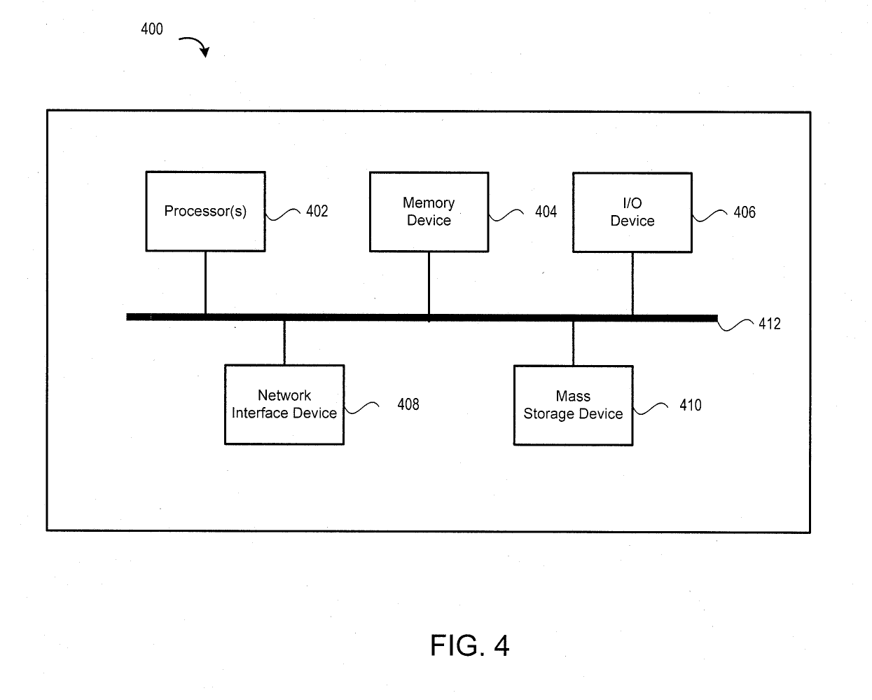

FIG. 4 is a functional block diagram of an embodiment of a general purpose computing device 400 suitable for use in executing the methods of the disclosed remote configuration management system 100 and services, in accordance with an embodiment. By way illustration, the computing device 400 can include, for example, a laptop computer, a stand-alone personal computer, and a server, to name a few. The computing device 400 includes one or more processors 402, a memory device 404, an input and output (I/O) device 406, a network interface device 408, and a mass storage device 410. The one or more processors 402 can be configured to execute instructions and to process data to perform one or more functions, such as the methods disclosed herein. The memory 404 can include one or more memory devices that store data, including without limitation, random access memory (RAM) and read-only memory (ROM). The I/O device 406 may include one or more components that allow a user of the computing device 400 to interface with applications executing in the computing device 400. For example, the I/O device 406 may include devices such as, for example, a keyboard, a mouse, a touch pad, a touch screen, a microphone, an accelerometer, a camera, or any other user input device configurable to work with the computing device 400. The I/O device 406 may also include, for example, a display (e.g., an LCD display, a CRT display, electronic ink, or a plasma display), a printer, a speaker, or any other output devices configurable to work with the computing device 400. The network interface device 408 may include any communication device for sending and receiving data across a network, including but not limited to, a network interface card, a modem or another network adapter capable of transmitting and receiving data over a network. The mass storage device can include, for example, a magnetic storage device (e.g., a hard disk), an optical storage medium (e.g., a CD or DVD drive), a high-definition optical storage medium, an electronic storage device (e.g., EPROM or a flash drive), or other data storage devices known in the art. The components of the computing device 400 are coupled together by way of a bus 412.

Although the systems, methods, and computer-readable media disclosed herein are described primarily in the context of updating application configurations, they may also be used to manage remote configuration distribution to servers and other computing environments. Additionally, while the systems, methods, and computer-readable media disclosed herein are described primarily in the context of updating application configurations by a developer, the application may alternatively be updated by another entity, such as an application publisher, a content creator, or other entities that may control the configurations of applications.

A number of computing systems have been described throughout this disclosure. The descriptions of these systems are not intended to limit the teachings or applicability of this disclosure. For example, the user systems described herein can generally include any computing device(s), such as desktops, laptops, video game platforms, television set-top boxes, televisions (e.g., internet TVs), computerized appliances, and wireless mobile devices (e.g. smart phones, PDAs, tablets, or the like), to name a few. Further, it is possible for the user systems described herein to be different types of devices, to include different applications, or to otherwise be configured differently. In addition, the user systems described herein can include any type of operating system (“OS”). For example, the mobile computing systems described herein can implement an Android™ OS, a Windows® OS, a Mac® OS, a Linux or Unix-based OS, or the like.

Further, the processing of the various components of the illustrated systems can be distributed across multiple machines, networks, and other computing resources. In addition, two or more components of a system can be combined into fewer components. For example, various systems can be distributed across multiple computing systems, or combined into a single computing system. Further, various components of the illustrated systems can be implemented in one or more virtual machines, rather than in dedicated computer hardware systems Likewise, the data repositories shown can represent physical or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Depending on the embodiment, certain acts, events, or functions of any of the algorithms, methods, or processes described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips or magnetic disks, into a different state. Each process described may be implemented by one or more computing devices, such as one or more physical servers programmed with associated server code.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a” and “an” are to be construed to mean “one or more” or “at least one” unless specified otherwise.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. Thus, nothing in the foregoing description is intended to imply that any particular feature, characteristic, step, module, or block is necessary or indispensable. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method for remotely modifying an application installed on a user device, comprising:
receiving, from a developer, an updated baseline configuration, a first rule that defines a first segment, a first configuration override associated with the first segment, a first priority associated with the first segment, a second rule that defines a second segment, a second configuration override associated with the second segment, and a second priority associated with the second segment, wherein the second priority is higher than the first priority;
receiving, from the user device, a request to update the application, and a client context;
determining whether the client context matches the first rule, the second rule, both the first rule and the second rule, or neither the first rule nor the second rule; and
transmitting, to the user device, the updated baseline configuration when the client context does not match either the first rule or the second rule, a first custom configuration based on the first configuration override when the client context matches the first rule but does not match the second rule; and a second custom configuration based on the second configuration override when the client context matches the second rule.

2. The method in claim 1 further comprising:
scheduling a time to update the configuration on the application;
defining a condition to initiate a request to update the application; and
transmitting, to the user device, the scheduled time to update the configuration and the defined condition to initiate a request to update the application.

3. The method in claim 1 further comprising:
authenticating the request to update the application when the request contains a set of verifiable credentials.

4. A non-transitory computer-readable medium embodying a program that is executable in a computing device, comprising:
obtaining, from a developer, a first document of name-value pairs for a set of modifiable variables incorporated into an application, at least one condition that defines membership in a segment, and a second document of name-value pairs for the set of modifiable variables incorporated into the application, the second document customized for members of the segment;
obtaining, from a client having the application installed on it, at least one attribute associated with the client, and a request to update the set of modifiable variables incorporated into the installed application;
determining whether the at least one attribute associated with the client matches the at least one condition that defines membership in the segment;
determining which of the first and second documents of name-value pairs to transmit to the client, in response to the request to update the set of modifiable variables incorporated into the installed application; and
delivering, to the client, the determined first or second document of name-value pairs for the set of modifiable variables incorporated into the application.

5. The non-transitory computer readable medium of claim 4 wherein the first and second documents of name-value pairs comprise name-value pairs that are being changed.

6. The non-transitory computer readable medium of claim 4 wherein the at least one attribute comprises a developer-defined attribute.

7. The non-transitory computer readable medium of claim 4 further comprising:
obtaining, from a developer, a third document of name-value pairs for the set of modifiable variables incorporated into the application, at least one condition that defines membership in a second segment, the third document customized for members of the second segment, and priority ratings for the segment and for the second segment; and
determining, based in part on the priority ratings, which of the first, second and third documents of name-value pairs to transmit to the client, in response to the request to update the set of modifiable variables incorporated into the installed application.

8. The non-transitory computer readable medium of claim 4 further comprising:
authenticating the request to update the set of modifiable variables incorporated into the installed application.

9. The non-transitory computer readable medium of claim 4 further comprising:
scheduling a time to update the set of modifiable variables incorporated into the installed application;
defining a condition to initiate a request to update the set of modifiable variables incorporated into the installed application; and
transmitting, to the client, the scheduled time to update the set of modifiable variables incorporated into the installed application and the defined condition to initiate a request to update the set of modifiable variables incorporated into the installed application.

10. The non-transitory computer readable medium of claim 4 further comprising:
creating a nested data format structure for the documents of name-value pairs for a set of modifiable variables incorporated into the application.

11. A system configured to update an application that is installed on a client, the system comprising:
at least one computing device comprising at least one processor; and
an update service application executable in the at least one computing device, the update service application configured to:
receive, from a developer system, an update to information associated with a configuration of modifiable variables incorporated into the installed application, the update information including an updated configuration of modifiable variables, a plurality of definitions of segments, a priority rating associated with each of the segments, and a configuration override associated with each of the segments;
receive, from the application installed on the client, a transaction request to update the installed application, the request also including user context information associated with the installed application and with the client;
determine, based on the updated information associated with a configuration of modifiable variables incorporated into the installed application and based on the user context information, an update to be delivered to the application installed on the client; and
transmit, in a transaction response to the application installed on the client, the determined update.

12. The system of claim 11 wherein the update service application executable in the at least one computing device is further configured to determine, sequentially, starting from a baseline configuration and progressing in an order from lowest priority rating to highest priority rating, an update to be delivered to the application installed on the client.

13. The system of claim 12 wherein the update service application executable in the at least one computing device is further configured to store the update and modify the stored update, sequentially, to arrive at a final update to be delivered to the application installed on the client.

14. The system of claim 11 further comprising an access control service application executable in the at least one computing device, the access control service application configured to authenticate the transaction request to update the installed application.

15. The system of claim 14 wherein the access control service application is further configured to provide access to the update service application when the transaction request from the application installed on the client lacks verifiable credentials.

16. The system of claim 15 wherein the provided access is a limited access.

17. The system of claim 11 further comprising an analytics service application executable in the at least one computing device, the analytics service application configured to analyze use of the application installed on the client.

18. The system of claim 11 wherein the update service application executable in the at least one computing device is further configured to:
schedule an update time;
define a condition to initiate a transaction request to update the installed application; and
transmit, to the client, the scheduled update time and the defined condition to initiate a transaction request to update the installed application.

19. The system of claim 11 wherein the update service application is further configured to create a nested data format structure of modifiable variables corresponding to the determined update.

20. The system of claim 11 further comprising a data store configured to store the update to information associated with a configuration of modifiable variables incorporated into the installed application.
